(19) United States
(12) Patent Application Publication
(10) Pub. No.: US 2009/0222335 A1
(43) Pub. Date: Sep. 3, 2009

(54) Coupons, Multiple Payments, and Recommendations in a Unified Storefront System

(75) Inventors: Sudha Gopal, Plano, TX (US); Leonardo Velazquez, Plano, IL (US); Lee Chow, Naperville, IL (US); David Piepenbrink, Chicago, IL (US); Helen Ly, Alameda, CA (US)

Correspondence Address: AT&T Legal Department - LNAP;Attn: Patent Docketing, Room 2A- 207, One AT & T Way, Bedminster, NJ, 07921, US

(73) Assignee: AT&T INTELLECTUAL PROPERTY, LP, Reno, NV (US)

(21) Appl. No.: 12/040,645

(22) Filed: Feb. 29, 2008

(51) Int. Cl. G06Q 30/00

(52) U.S. Cl. 705/14

(57) ABSTRACT

A unified storefront system includes a recommendation module, a coupon module, and a payment module. The recommendation module is adapted to recommend and cross promote a first plurality of assets based on a user context and based on an access device. The coupon management module is coupled to the recommendation module, and the coupon management module adapted to store a coupon associated with a user account. The payment module is coupled to the recommendation module, and the payment module is adapted to provide an ability to purchase a first asset with a plurality of payment methods during a single transaction.

### FIELD OF THE DISCLOSURE

The present disclosure generally relates to communications networks, and more particularly relates to a unified storefront system.

### BACKGROUND

Individuals can access online databases to purchase a variety of products. Some products, however, are accessible only through a particular device. Currently, the products available for purchase are located in different online databases, requiring the customer to use a plurality of devices to access, search, and purchase products associated with the various devices. For example, a set-top box may be used to purchase a video-on-demand, and a cellular telephone may be used to purchase a ring tone. Thus, the customer must use one device to purchase certain products associated with that device, and use a second device if the customer wishes to purchase certain products associated with the second device. While using the different devices, the customer is also provided with recommendations for different products, and the user can use a coupon code to purchase a product associated with the different devices.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an embodiment of a portion of an unified storefront system;

FIG. 2 is a flow diagram of a method for purchasing an asset with a coupon in the unified storefront system of FIG. 1;

FIG. 3 is a flow diagram of a method for recommending an asset in the unified storefront system of FIG. 1; and

FIG. 4 is a flow diagram of a method for providing multiple payment options for the purchase of a single asset in the unified storefront system of FIG. 1.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

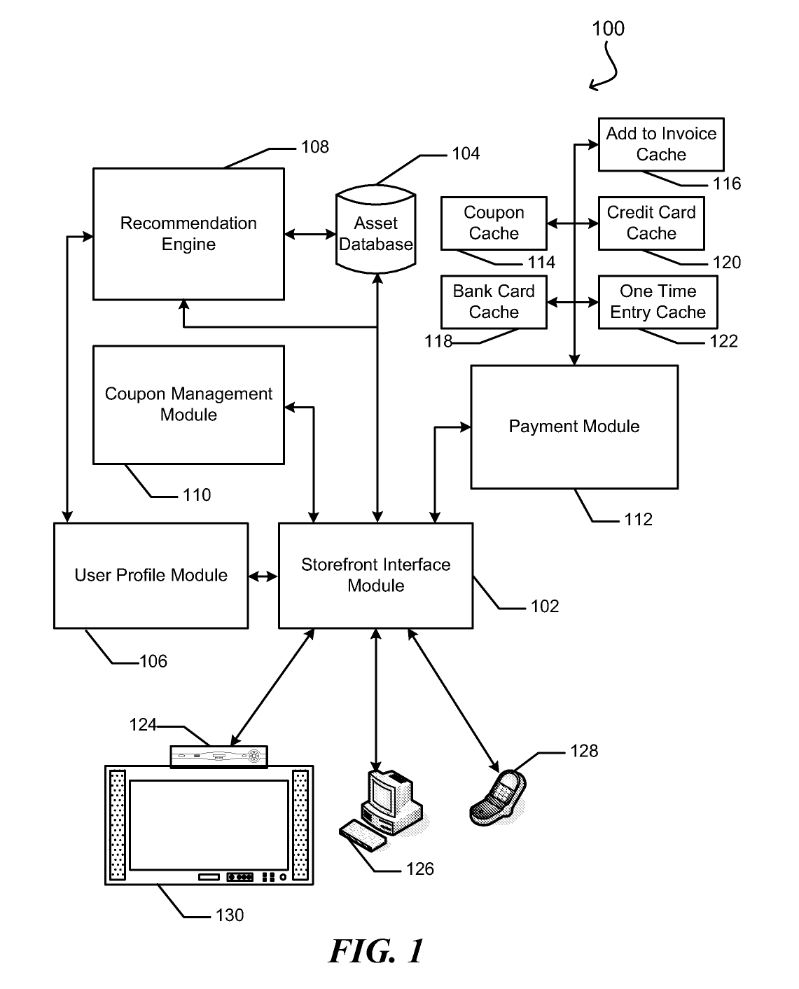

FIG. 1 shows a unified storefront system 100 including a storefront interface module 102, an asset database 104, and a user profile module 106. The unified storefront system 100 also includes a recommendation engine 108, a coupon management module 110, and a payment module 112. The storefront interface module 102 is in communication with the asset database 104, the user profile module 106, the recommendation engine 108, the coupon management module 110, and the payment module 112. Additionally, the recommendation engine 108 is in communication with the asset database 104 and the user profile module 106. The payment module 112 is in communication with a coupon cache 114, an add to invoice cache 116, a bank card cache 118, a credit card cache 120, and a one time entry cache 122.

The storefront interface module 102 can provide the user of a set-top box 124, a computer 126, or a cellular telephone 128 with access to the unified storefront system 100. The storefront interface module 102 preferably accomplishes this by presenting the user with a graphical user interface (GUI) for navigation on a display device associated with the access device, such as a television 130 when the access device is the set-top box 124. The user can use the GUI to browse the unified storefront system 100 or to enter coupon codes associated with specific assets available for purchase and stored in the asset database 104.

The asset database 104 stores videos-on-demand (VODs), digital songs, digital video disc (DVD) movies, compact disc (CD) music, cellular telephone wallpapers, ringtones, applications, games, and the like as physical and digital assets available for purchase by the user of the unified storefront system 100. The different assets can be divided into different asset categories, such as movies, music, and the like and each category can include multiple assets. For example, the asset category for movies can include videos-on-demand, DVDs, and the like.

As the user navigates through the unified storefront system 100, the user profile module 106 can store browsing, searching, purchasing history, post purchasing events, and information identifying the access device used to connect with the unified storefront system for the user as a customer profile. The user profile module 106 can update the customer profile every time the user accesses the unified storefront system 100 with any one of the access devices. Thus, the customer profile information can be complied for the user from multiple access devices, such as the set-top box 124, the computer 126, and the cellular telephone 128. The information obtained for a given user is utilized by the other components in the unified storefront system 100.

For example, the recommendation engine 108 utilizes the customer profile stored in the customer profile module 106 of the user logged into the unified storefront system 100 to aid the recommendation of assets to the user. The recommendation engine 108 can use the customer profile to determine what asset or assets the user typically browses for, searches for, or purchases and recommend physical and digital assets based on the customer profile complied from the usage on all of the access devices. Thus, based on the customer profile, the recommendation engine 108 determines assets in which the user may have interest, and recommends these assets to the user.

The recommendation engine 108 can also use a context for the user while accessing the unified storefront system 100 to aid in recommending assets. The context may include the current page of the unified storefront system 100 being displayed to the user, a landing page, a category level page, an asset level page, and the like. The landing page is the first page displayed to the user when accessing the unified storefront system 100. The category level page displays the different assets associated with a specific category selected by the user. The asset level page displays details about a specific asset selected by the user. As the user navigates in the unified storefront system 100, the context may change according to the current page being viewed by the user on one of the access devices. Thus, the recommendation engine 108 can generate recommendations related to assets, offers, promotions, and advertisements specific to the user logged into the unified storefront system 100 and the context for the user, in order to enhance opportunities for customer purchases.

The recommendation engine 108 can use certain criteria based on the location, in the unified storefront system 100, of the user and the user specific information to generate suggestions to be displayed to the user. The recommendations generated can be for both purchasable and non-purchasable assets, such as related offers and advertisements for both physical and digital assets. The purchasable and non-purchasable assets can also be identified as consumable and non-consumable assets. Consumable assets can be digital assets that can be downloaded and used with one of the access devices, and non-consumable assets can be assets that cannot be downloaded for use with one of the access devices. The purchasable and non-purchasable assets include VODs, CDs, DVDs, advertisements, offers, promotions, wireless ringtones, wireless ringback-tones, Voice over Internet Protocol (VoIP) ringtones, VoIP ringback tones, downloadable audio files, and the like.

The coupon management module 110 can provide the user with the ability to view all the coupons currently associated with the customer account, enter new coupons for future use, and select a coupon to retrieve all of the assets that the coupon can be applied to from the set-top box 124, the computer 126, and the cellular telephone 128. The coupon management module 110 can provide these features to the user through the GUI of the interface module 102. The coupon management module 110 can store various types of coupons including outright percent discount, outright free asset, conditional percent discount, conditional free asset, stackable coupon, single use, multiple use, clickable coupon, and the like. The outright percent discount and the outright free asset coupons can allow the user to use the coupons without the user having to meet a special condition. However, the conditional percent discount and the conditional free asset coupons can require the user to meet some specific condition before the user is allowed to use the coupons, such as requiring the user to purchase multiple assets before allowing the coupons to be applied to the purchase price of the assets. The multiple assets required for the conditional coupons may be the same type of asset or different types of assets, such as two ringtone assets or a ringtone asset and a VOD asset. Stackable coupons are coupons that are capable of being used along with other coupons during a single transaction. Single use coupons are coupons that can only be used once, and multiple use coupons are coupons that can be use a number of times. Clickable coupons are coupons that upon the user selecting the coupon, the user can purchase the asset associated with the coupon. The coupon management module 110 can allow the user to store and access coupons for an asset associated with one access device through all of the access devices.

When the user is ready to purchase an asset, the payment module 112 can retrieve all the available payment methods for the user and can display these to the user through the GUI of the storefront interface module 102. The available payment methods can be a stored coupon, entering a coupon code, a stored credit card, a stored bank card, add to invoice, one time entry of a credit card or a bank card, and the like. The payment module 112 can access the different payment methods through the coupon cache 114, the add to invoice cache 116, the bank card cache 118, the credit card cache 120, and the one time entry cache 122. Upon selection of a payment method, the payment module 112 can validate and process the payment through the applicable backend billing systems. If the user selects the add to invoice option, then a billing event to make an invoice for the purchase of the asset can be sent to the applicable backend system and the credit limit for the user can be updated in the add to invoice cache 116.

If the user selects the coupon payment option, all available coupons for the specific asset can be presented to the user from the coupon cache 114. The payment module 112 can allow the user to select a coupon that is allocated to the user account or enter a coupon code that has not been previously entered into the user account through the coupon management module 110, but that can be used for the purchase of the selected asset. Depending on the price of the asset and the value of the coupon, the user can either pay the entire purchase price or can pay a portion of the purchase price for the selected asset with the coupon. If the coupon covers partial payment, after applying the coupon to the purchase price of the asset, the payment module 112 can present the user with additional payment options to complete the transaction. The additional payment options can be any of the payment methods listed above. Additionally, if stackable coupons are applicable, then the option to pay by coupon can be one of the options presented to the user.

The unified storefront system 100 can provide the user with the ability to view and purchase the assets stored in the asset database 104 from each of the access devices. The user can utilize the GUI to browse the unified storefront system 100 or enter coupons in the user account through the coupon management module 110. The recommendation engine 108 can also present the user with assets that are associated with an access device other than the current access device being used. Thus, the unified storefront system 100 can provide the user with the ability to purchase any asset stored in the asset database 104 through any one of the access devices. For example, the user can search and purchase a video-on-demand asset, which is typically associated with the set-top box 114, by accessing the unified storefront system 100 via the set-top box, the computer 116 or the cellular telephone 118.

While accessing the unified storefront system 100 from any of the access devices, the user can access the coupon management module 110, browse and search for different assets, receive recommendations for purchase and non-purchasable assets from the recommendation module 106, and purchase assets through the payment module 112. While accessing the coupon management module 110, the user can select a coupon and view all of the available assets associated with the coupon. Upon the user selecting an asset for purchase, the payment module 112 can display the different payment methods available to the user and the user can select one or more payment methods for the purchase of the asset. Depending on the type of coupons used, the user can apply multiple coupons to the purchase of a single asset or can use multiple other payment methods including the add to invoice option to purchase the asset.

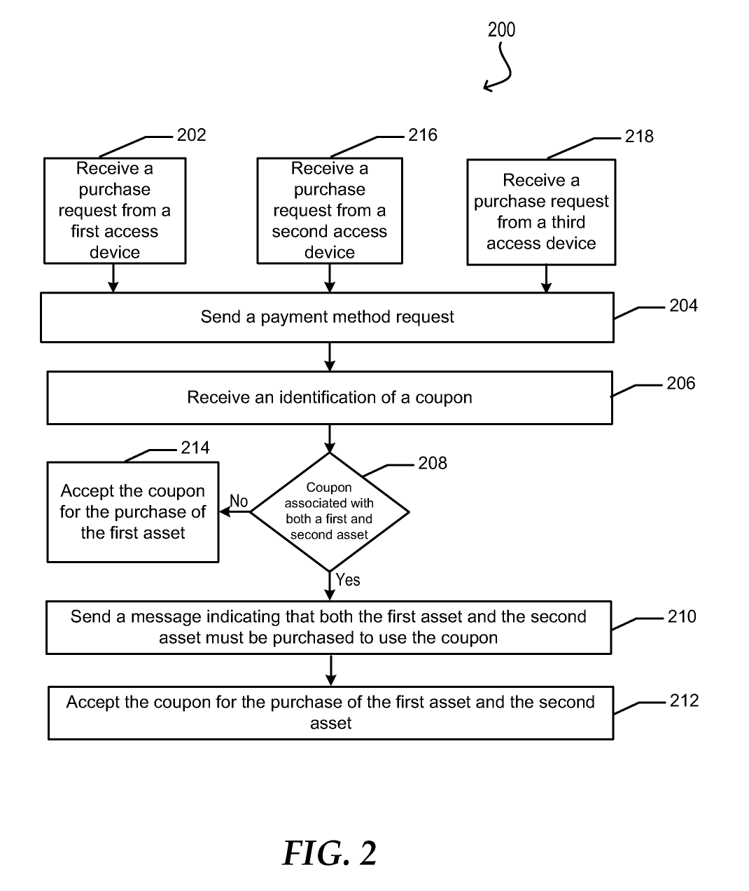

FIG. 2 is a flow diagram of a method 200 for providing for a purchase of an asset by use of a coupon in the unified storefront system 100. At block 202 a purchase request is received from a first access device. The access device can be a set top box, a computer, a cellular telephone, and the like. The purchase request can be for an asset associated with either the first access device or another access device. A payment method request is sent at block 204. The payment method request can provide a user with a list of available payment methods. The payments methods can include coupons, stored credit cards, stored bank cards, add to invoice, one time entry of a credit card or a bank card, and the like. At block 206, an identification of a coupon is received. A determination is made whether the coupon is associated with only a first asset or both the first asset and a second asset at block 208. The first and second assets can be the same type of asset or different types of assets, such as two ringtone or a ringtone and a VOD. At block 210, if the coupon is associated with both the first asset and the second asset, a message is sent indicating that both the first asset and the second asset must be purchased to use the coupon. Upon selection of the second asset, the coupon is accepted for purchasing both the first asset and the second asset at block 212. If the coupon is only associated with the first asset, the coupon is accepted for the purchase of the first asset at block 214. At block 216, a purchase request is received from a second access device and the flow diagram continues at block 204 as stated above. At block 218, a purchase request is received from a third access device and the flow diagram continues at block 204 as stated above. The second and third access devices can be different access devices of the same user or they can be the same type of access device used by a different user.

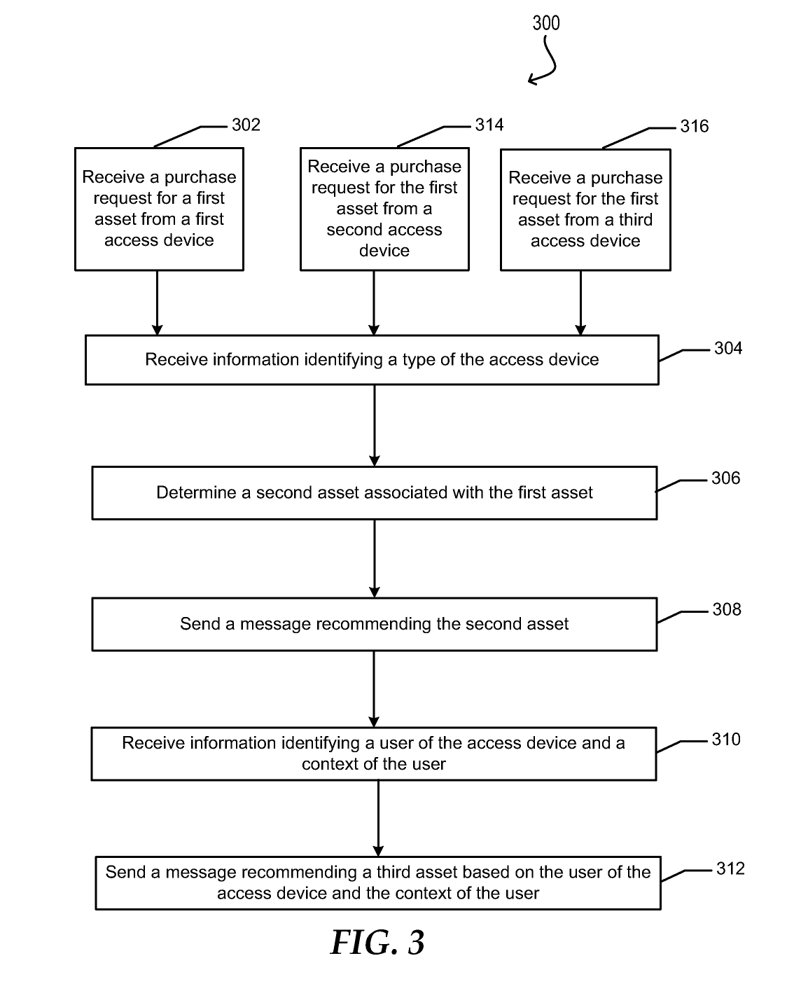

FIG. 3 is a flow diagram of a method 300 for recommending an asset in the unified storefront system 100. At block 302, a purchase request for a first asset is received from a first access device. Information identifying a type of the access device is received at block 304. The type of access device can be a set-top box, a computer, a cellular telephone, and the like. At block 306, a second asset associated with the first asset is determined. The second asset can be a purchasable or a non-purchasable asset such as a VOD, a CD, a DVD, an advertisement, an offer, a promotion, a wireless ringtone, a wireless ringback-tone, a Voice over Internet Protocol (VoIP) ringtone, a VoIP ringback tone, a downloadable audio file, and the like. A message recommending the second asset is sent at block 308. At block 310, information identifying a user of the access device and a context of the user is received. The context can be a landing page, a category level page, an asset level page, and the like. A message is sent recommending a third asset based on the user of the access device and based the context of the user at block 312. At block 314, a purchase request for a first asset is received from a second access device and the flow diagram continues at block 304 as stated above. At block 316, a purchase request for a first asset is received from a third access device and the flow diagram continues at block 304 as stated above. The second and third access devices can be different access devices of the same user or they can be the same type of access device used by a different user.

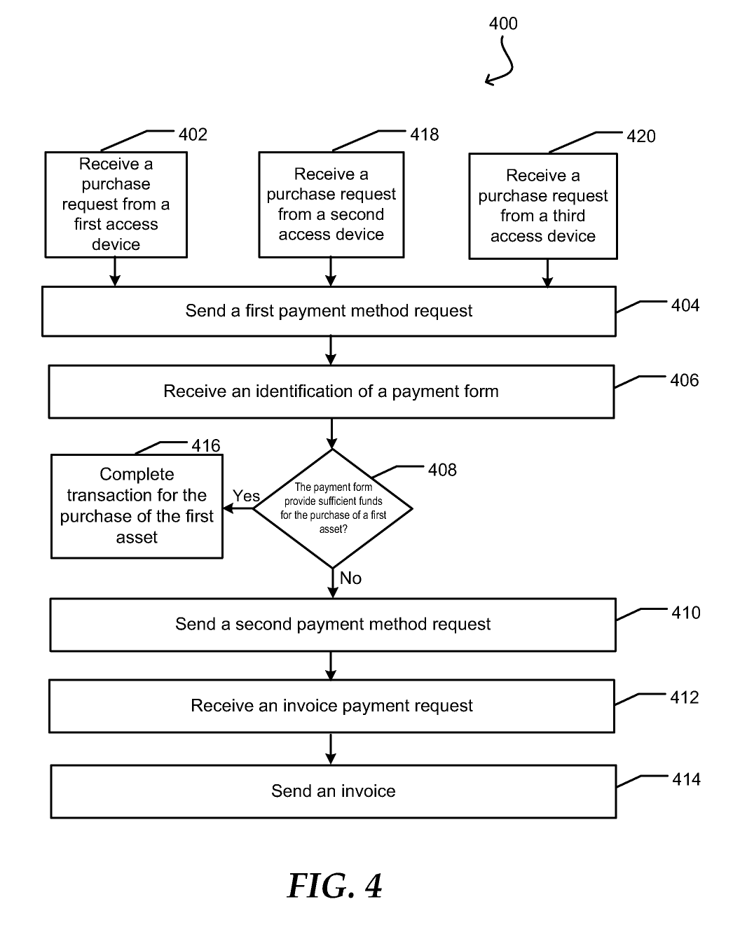

FIG. 4 is a flow diagram of a method 400 for providing the multiple payment option for the purchase of a single asset in the unified storefront system 100. At block 402, a purchase request is received from a first access device. The purchase request can be for an asset associated with either the first access device or another access device. A first payment method request is sent at block 404. At block 406, an identification of a payment form is received. A determination is made whether the payment form provides sufficient funds for the purchase of the asset at block 408. At block 410, if the payment form does not provide sufficient funds, a second payment method request is sent. An invoice payment request is received at block 412. At block 414, an invoice is sent to a user of the access device. If the payment form does provide sufficient funds for the purchase of the asset, then the transaction of the purchase of the asset is completed at block 416. At block 418, a purchase request is received from a second access device and the flow diagram continues at block 404 as stated above. At block 420, a purchase request is received from a third access device and the flow diagram continues at block 404 as stated above. The second and third access devices can be different access devices of the same user or they can be the same type of access device used by a different user.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGS. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A unified storefront system comprising:
a recommendation module adapted to recommend and cross promote a first plurality of assets based on a user context and based on an access device;
a coupon management module coupled to the recommendation module, the coupon management module adapted to store a coupon associated with a user account; and
a payment module coupled to the recommendation module, the payment module adapted to provide an ability to purchase a first asset with a plurality of payment methods during a single transaction.

2. The unified storefront system of claim 1 further comprising:
a unified storefront interface module in communication with the recommendation module, the coupon management module, and the payment module, the unified storefront interface module adapted to allow a plurality of access devices to communicate with the recommendation module, the coupon management module, and the payment module.

3. The unified storefront system of claim 1 wherein the payment module is further adapted to allow payment of the first asset with the coupon stored in the coupon management module.

4. The unified storefront system of claim 3 wherein the payment module is further adapted to determine that the coupon is associated with the first asset and a second asset and adapted to send a message indicating that both the first asset and the second asset must be purchased to use the coupon.

5. The unified storefront system of claim 1 wherein the user context is selected from the group consisting of a landing page, a category level page, and an asset level page.

6. The unified storefront system of claim 1 wherein the plurality of payment methods is selected from a group consisting of a coupon, a credit card, a bank card, and an invoice.

7. A method comprising:
receiving a first purchase request for a first asset;
sending a payment method request;
receiving an identification of a coupon in response to the payment method request;
determining that the coupon is associated with the first asset and a second asset, the second asset being different than the first asset; and
indicating that the first and second assets must be purchased to use the coupon.

8. The method of claim 7 wherein the first asset is a video on demand program and the second asset is a telephone ringtone.

9. The method of claim 7 wherein the message includes a link that, when selected, sends a second purchase request for the second asset.

10. The method of claim 7 further comprising:
accepting the coupon as payment for the first and second assets.

11. A method comprising:
receiving a purchase request from a first access device for a first asset associated with a second access device different from the first access device;
receiving information identifying the first access device;
determining a second asset associated with the first asset that is compatible with the first access device; and
recommending the second asset.

12. The method of claim 11 wherein the second asset is an advertisement.

13. The method of claim 11 wherein the first asset is a video on demand program and the second asset is a telephone ringtone.

14. The method of claim 11 wherein the first access device is a cellular telephone and the second access device is a television.

15. The method of claim 11 further comprising:
receiving information identifying a user of the first access device;
receiving information identifying a user context; and
sending a recommendation for a third asset based on the user and the user context.

16. The method of claim 15 wherein the user context is selected from the group consisting of a landing page, a category level page, and an asset level page.

17. A method comprising:
receiving a purchase request for an asset;
sending a first payment method request;
receiving an identification of a payment form;
determining that the payment form does not provide sufficient funds for the purchase of the asset;
sending a second payment method request to cover a remainder of the purchase of the asset; and
receiving an invoice payment request to apply the remainder of the purchase of the asset to a service provider account associated with a user.

18. The method of claim 17 wherein the asset is a telephone ringtone.

19. The method of claim 17 wherein
sending an invoice to the user, a balance due for the invoice including a charge associated with a service provided by the service provider to the user and the remainder of the purchase of the asset.

20. The method of claim 17 wherein the service provider is selected from the group consisting of a telephone service provider and a television service provider.

21. The method of claim 17 wherein the service is television service.

22. The method of claim 17 wherein the payment form is a coupon.
